(19) United States
(12) Patent Application Publication
(10) Pub. No.: US 2007/0252023 A1
(43) Pub. Date: Nov. 1, 2007

(54) Tube System for Supplying a Fluid, Preperably for Subsoil Irrigation

(76) Inventors: Herbert Walter, Fluorn-Winzeln (DE); Gisbert Staupendahl, Jena (DE)

Correspondence Address: NATH & ASSOCIATES, 112 South West Street, Alexandria, VA, 22314, US

(21) Appl. No.: 11/792,309

(22) PCT Filed: Dec. 1, 2005
(86) PCT No.: PCT/EP05/12815

§ 371 Date: Jun. 5, 2007

(30) Foreign Application Priority Data
Dec. 6, 2004 (DE) 10 2004 058 858.9

(51) Int. Cl. B05B 1/20

(52) U.S. Cl. 239/734

(57) ABSTRACT

The invention relates to a tube system for supplying a fluid, preferably for subsoil irrigation. Said tube system consists of an inner tube (2) which supplies the fluid and is arranged inside an outer tube (1′) at a distance therefrom. A buffer volume is formed between the inner tube (2) and the outer tube (1), said buffer volume being sub-divided into provision chambers (8) by constrictions (7) of the outer tube (1′). The fluid (3) supplied by means of the inner tube (2) enters the chambers (8) by means of portioning holes (4). The outer tube (1′) preferably consists of a porous material. In order to fill the buffer volume (5) with a fluid, the cross-section of the openings of the outer tube (1) is essentially smaller than the cross-section of the portioning holes (4) of the inner tube (2). To this end, the inner tube (2) consists of a fluid-impermeable material, and the outer tube consists of a porous or perforated material.

The invention relates to a tube system for supplying a fluid, that is, for supplying liquids or gases, in particular water, preferably for subsoil irrigation of the type cited in the preamble to claim 1.

In such tube systems it is important that small defined fluid quantities are supplied in order to assure a continuous or semi-continuous supply over extended intervals of time without complex regulating mechanisms and to be able to use the smallest possible quantities of fluid.

Preferred areas of application are subsoil irrigation of large areas of vegetation, aeration of waste water channels or contaminated waters, and the regeneration of contaminated soil, whereby the tube systems can also be employed above the surface of the soil.

A significant disadvantage of most of the previously known tube systems is that they do not assure a uniform supply of the fluid over extended distances and/or in hilly terrain without controls that are quite complex.

Known from CH 321 765 is a spray irrigation tube that comprises at least two conduits, and the fluid flows out through the spray apertures in the wall thereof. However, the spray pressure exerted on the spray apertures disadvantageously drops as the distance from the feed site increases.

This is also true for the system known from DE 202 11 742 U1, in which however a plurality of parallel membrane tubes are filled with fluid via controlled valves.

For a uniform fluid supply, tube systems having large fluid outflow quantities per length interval and time interval, e.g. several liters per hour and meter, require a pump technology with a high peak performance, even for short operating intervals, which is complicated and expensive and is furthermore susceptible to problems. It is only with such a technology that, first of all, the small quantity of fluid outflow per length interval and unit of time that is desired in the current means is possible, and secondly, an approximately uniform supply of the fluid through long lengths of tube is possible. The major drop in pressure per unit of length with high outflow quantities that occurs when not enough fluid is delivered is responsible for the uneven supply.

In any case, the maximum length for a tube system having only a single feed site for the fluid itself when employing high performance pump technology during the use of most conventional tube types is limited by the pressure of the fluid quantity supplied, since the drop in pressure that occurs over long tube lengths automatically leads to a reduction in this quantity and thus to uneven fluid output, and thus in particular leads to uneven irrigation.

Therefore a reduction in the outflow quantity due to the fluid pressure in the tube has only very limited efficacy, since it automatically leads to short tube lengths with which a somewhat uniform fluid supply can still be attained.

In agriculture and gardening, types of tubes with very small individual holes for direct transfer of the fluid to the adjacent soil can be used to supply small fluid quantities over longer lengths. However, over time these types of tubes are extremely susceptible to problems because the holes become clogged with impurities, in particular when there is an extended interruption in the irrigation, e.g. outside of the growing season, or even extremely fine hair-like roots growing into the tubes.

Some remedy for this is provided by the pressure-independent tube system known from EP 0 824 306 B1, in which an elastic inner tube that has outlet apertures is disposed inside an outer tube that acts as a protective cover and that has a slit-like aperture running along a cover line. In this system, pressure-independent provision of the fluid is to be attained using the pressure-dependent deformation of the inner tube cross-section. However, in many applications, e.g. in subsoil irrigation, this system has the disadvantage that during extended periods without pressure, that is e.g. during periods of maintenance work or non-irrigation periods outside of the growing seasons, there is irreversible deformation of the tube cross-section, e.g. due to the pressure of the soil, so that the properties of the tube have been disadvantageously changed when operations begin.

Apart from this, the system known from EP 0 824 306 B1 is complex and fraught with problems during production and handling, having an outer intake conduit with high tensile strength and with a non-closed cross-section and having where necessary a filter material inserted between the actual elastic inner tube that supplies or takes up the fluid and the slitted outer tube, and having an elastic reinforcement for stabilizing the system.

Finally, with this system there is the risk that roots will penetrate through the relatively wide gap in the outer tube into the system and damage it over time.

FR 2 713 044 A1 describes a system comprising an inner tube and an outer tube in which the outer tube comprises porous material. The dimensioning of the tubes should be such that for attaining a uniform water output the pressure is reduced in two stages, for which purpose the pores of the outer tube must have a relatively large cross-section compared to the portioning apertures of the inner tube.

This tube system has the profound disadvantage that the quantity of water output is largely a factor of differences in elevation in the terrain to be irrigated.

This disadvantage is avoided in the system known from U.S. Pat. No. 3,874,598 in that the buffer volume between outer tube and inner tube is divided into individual provision chambers. However, in this solution the outer tube does not comprise a porous material with fine pores. On the contrary, in this solution the apertures of the outer tube are significantly larger than the apertures of the inner tube. In addition, with this tube it is not possible to assure uniform water supply on inclined terrain when segment lengths are in the meter range.

The underlying object of the invention, proceeding from the tube system in accordance with FR 2 713 044 A1 with the features cited in the preamble to claim 1 is to fashion this system such that the aforesaid disadvantages are avoided, while also providing in the inventive system an outer stable protective cover in which is arranged a more flexible inner tube that supplies the fluid.

The object is attained with the features provided in claim 1.

According to the basic idea of the invention, the buffer chamber between the outer tube and the inner tube is divided into individual provision chambers, as in the solution in accordance with U.S. Pat. No. 3,874,598, into each of which chambers a portioning hole of said inner tube opens, the cross-section of the apertures of the outer tube being significantly smaller however than the cross-section of the apertures of the inner tube.

Together with the dimensioning of the apertures, the effect of this segmentation is that when the tube system is not placed horizontally, the tube surroundings in more elevated and in lower areas is uniformly supplied with adequate pressure and with an adequate quantity of fluid.

The result of the dimensioning of the pores and portioning holes, which preferably correspond to the suggestion in accordance with claim 14, is that the fluid fed via the inner tube into the intermediate space between inner tube and outer tube does not flow out into the tube surroundings through the apertures of the outer tube that are smaller in cross-section until there is a certain pressure.

As in the known system, in this case as well the outer tube assures resistance against environmental factors. Suitable for instance are porous tubes with high stability, e.g. membrane tubes with a wall thickness of d_{A}=5 mm and an inner diameter of D_{A}=1.5 inches.

Such tubes are resistant to ground pressure, soiling, and the growth of very small roots, which is due in particular to the large number of small fluid outflow apertures, that is pores e.g.

Due to the dimensioning of the cross-sectional apertures, a buffer volume builds up in the intermediate area between inner tube and outer tube, and it acts as a fluid reservoir and therefore ensures that fluid provided via the inner tube travels via the portioning holes into the intermediate area between inner tube and outer tube at a higher pressure, e.g. a pressure of several bars, and that the fluid is supplied to the tube surroundings from this intermediate area through the fine apertures of the outer tube, e.g. a porous fabric.

The portioning holes of the inner tube can also possess complex functions and properties, e.g. they can be pressure-compensating or self-cleaning.

Options for self-cleaning holes are e.g. the subject-matter of claims 19 and 20.

In accordance with claim 2, the segmentation suggested with the invention can be attained in a simple manner in that the outer tube is provided with constrictions that are preferably positioned equidistant against the outer side of the inner tube.

In accordance with another variant provided in claim 3, for forming the provision chambers the inner tube preferably has equidistant annular convexities that are positioned against the inner surface of the outer tube.

This variant offers a number of important configuration options when, as provided in claim 4, the wall thickness of the inner tube, which comprises elastic material, is thinner in the area of the annular convexities compared to the adjacent inner tube walls so that when the fluid pressure is increased in the interior of the inner tube the annular convexities are positioned against the adjacent inner tube walls.

Thus according to the suggestion in accordance with claim 5, it is possible to have self-segmentation of the buffer chamber by means of the annular convexities by adjusting the pressure in the inner tube.

This configuration possibility opens up a number of new options when, as suggested in claim 6, the inner tube and the buffer chamber can each be connected via controllable valves to a discrete fluid source, preferably to a water connection and/or a compressed air source.

Thus for instance according to the suggestion in accordance with claim 7, if a fluid, preferably water, is fed directly into the buffer chamber, for the purpose of rapid irrigation, it is possible to eliminate the segmentation, specifically with a reduction in the pressure in the inner tube. In this case the tube system has a water outflow rate that is the same as the simple membrane tube.

Another advantage is that when the segmentation is deactivated, that is, when the pressure in the inner tube is reduced, the entire tube system can be cleaned very effectively. For this purpose, according to the suggestion in accordance with claim 8, a fluid, preferably water or compressed air, is to be fed under high pressure into the inner tube and/or the into the buffer chamber while reducing the pressure in the inner tube. Using this measure the particles clogging the portioning holes or pores can be effectively removed.

In this, the pressure can be varied, as is suggested in claim 9, or in accordance with claim 10 the pressure can be generated in brief pressure shocks at time intervals.

In accordance with another variant that is provided in claim 11, the inner tube can comprise elastic material such that it is positioned across its entire length on the inner wall of the outer tube when the fluid pressure increases, which eliminates the entire buffer chamber for a period so that the fluid flows out of the inner tube directly through the porous outer tube in the vicinity of the portioning holes of the inner tube.

If there is no self-segmenting of the buffer chamber, in accordance with claim 12 the constrictions of the outer tube or the convexities of the inner tube can be joined fluid-tight, preferably welded, to the inner tube.

If the tubes comprise thermoplastic material, the result is simple production using a tool to be employed from outside that effects heat deformation when in accordance with claim 13 the material of the outer tube possesses a lower melting point than the material of the inner tube. Materials suitable for the outer and inner tube are fundamentally polymer materials, and in accordance with claim 14 in the context of task distribution the inner tube should have a higher elasticity than the outer tube.

With the measures described in the foregoing it is possible to rinse and clean the inventive tube system in order to clean the holes or pores of the tube that have clogged with calcium particles, rust particles, or the like. According to the suggestions in accordance with claims 19 and 20, this cleaning can be further supported by the design of the portioning holes or the inner tube.

With these measures, using the elasticity of the inner tube, the design of the portioning holes provides that intentional variation of the difference in pressure between inner tube and buffer volume leads to an effective “kneading” process in the immediate environment of the portioning holes. In accordance with claim 19, the portioning holes of the inner tube can be funnel-shaped. In accordance with claim 20, the wall of the inner tube is somewhat indented in the area of the portioning holes and has a thinner wall thickness in this area.

Using the aforesaid “kneading” process, even stubborn layers and encrustations in the hole area can be loosened and rinsed out. In this manner the use of the tube system is assured for a very long period of time.

In the inventive embodiment of the tube system, the fluid outflow quantity is practically not affected by the elastic properties of the inner tube and outer tube, it does not depend on the e-modulus of the materials used, and there is therefore also no relationship to the temperature at which the tube system is used.

The additional filter shell suggested e.g. in EP 0 824 306 B1 is not necessary per se with the inventive solution. However, as suggested in claim 24, it can be advantageous to insert upstream of the tube system an input filter that filters out impurities such as e.g. suspended organic and inorganic particles.

Nor is there any need for additional reinforcement of the tube system when the material of the outer tube has the required stability. Likewise, the chemical composition of the outer tube can be selected such that the tube has adequate protection against destruction by environmental factors, e.g. even by rodents.

In the context of the invention explained in the foregoing, in accordance with claim 15 the outer tube comprising porous material can be embodied e.g. as a soaker tube, floating tube, or membrane tube.

In order to attain its flexibility with the required resistivity, in accordance with claim 16 a mixture of rubber and polymer substances is suggested for the material.

For ensuring that the fluid flows out uniformly over great distances it is particularly important to match the position of the provision chambers and the number of portioning holes of the inner tube that open into said provision chambers such that the loss in pressure in the inner tube that is a factor of the tube length and the reduction in the quantity of the fluid flowing out through the portioning holes of the inner tube that is caused thereby is compensated for attaining a constant fluid outflow quantity per unit of length of the tube system, as is provided in claim 21.

The effect sought with the invention is significantly enhanced in that according to the inventive suggestion the material of the outer tube is selected and its apertures are dimensioned such that they do not open unless a pre-specified pressure threshold is exceeded, preferably 0.3 bar. The result of this is that below a certain pressure the outer tube does not permit the fluid to pass, that is, it is sealed, and above this pressure the pressure threshold increases the fluid outflow quantity supplied proportional to the increase in pressure after a certain non-linear transition area.

This results in the properties, explained in the following, that make the inventive tube system practically universal for a wide variety of irrigation tasks.

1. When the tube is placed horizontally, e.g. for irrigating grassy surfaces in sports stadiums, first the buffer volume between the two tubes fills completely with fluid flowing out due to the water pressure in the inner tube, which must be greater than the threshold for the pressure in the outer tube. Since the gravitational pressure of the fluid in the normal tube diameters, which are in the centimeter range, is imperceptibly small, no fluid flows out until the pressure in the filled buffer volume exceeds the threshold for the outer tube. The following pronounced advantages result from this:
a. Due to the pressure acting on all sides, the fluid flows out uniformly over the entire tube length, the constant equilibrium value being attained when the inflow through the portioning holes of the inner tube equals the quantity flowing out of the outer tube. If the quantity flowing out is too high due to the relatively high porosity of the porous outer tube, the pressure in the buffer volume drops below the threshold and the outflow of water stops automatically until sufficient pressure has built up again in the buffer volume.
b. This effect has the advantage that the system can be designed for tube production for extremely small outflow quantities using the number of portioning holes per unit of length.
c. Another advantage is that by selecting the pressure in the inner tube for each desired tube configuration, a large range is available for regulating the outflow quantity of the tube system. Given realistic values for the threshold of the outer tube, values of e.g. p_{S}=0.3 bar, and a regulating interval for the pressure in the inner tube of P_{F}=1 to 8 bar, a regulating range can be attained for the outflow quantity with the factor of 1 to 8.
d. Additional external regulating circuits are not required.

2. The pressure threshold suggested in claim 18 for the outer tube has a particularly advantageous effect when placing the tube system in hilly terrain.

With elevation differences Ah that correspond to gravitational pressure PG for the fluid, which is small compared to the threshold p_{S}, as described the buffer volume and in particular the buffer volume segmented into provision chambers fills with fluid such that the fluid flows out largely uniformly across the length of the tube system, preferably the entire segment area. In this case the lengths of the provision chambers should be dimensioned such that the tube parameters, specifically the fluid pressure in the inner tube, the portioning hole diameter, and the threshold, are matched to one another in an optimum manner in terms of a uniform fluid supply.

In this case it should in particular be avoided that the lengths of the provision chambers are so large and the flow-through quantities through the portioning holes of the inner tube are so small that, due to the effect of the gravitational pressure in provision chambers that are placed lower on the whole with the inner pressure building up in the buffer volume, a significantly higher outflow quantity of fluid through the outer tube results than in the provision chamber placed higher. In this case an optimum must be found for the terrain, and it is possible to use relatively short provision chambers, into which naturally a required number of portioning holes must open, to attain a largely uniform supply of the fluid across the tube length.

With the inventive tube system, it is possible to supply a fluid, preferably water, across long lengths up to several kilometers. The surface of the outer tube is fashioned such that its function is not negatively impacted by long-term effects such as soiling the fluid outlet apertures or roots growing into these apertures. In this case the material can be selected such that the tube system is flexible and stable, such that it can be placed with no problem using conventional technology, but such that on the other hand it is protected against deformations by the pressure of the ground or vehicles that can limit functions.

There are two further options for the tube system, and these are the subject-matter for claims 22 and 23.

In accordance with claim 22, it is possible to add completely soluble fertilizers via the tube system, e.g. during irrigation of vegetation, this permitting extremely effective and inexpensive fertilization.

According to another suggestion in accordance with claim 23, the system is also suitable for subsoil heating, e.g. of grassy surfaces in sports stadiums. In this case it is merely necessary to supply adequate heating capacity via the fluid. In this application it is possible to use the self-segmentation to attain high-performance heating in that the heated fluid is added to the surrounding ground via the puffer chamber.

The subject-matter of the invention is explained in detail in the following using the exemplary embodiments, which are schematically depicted in the drawings.

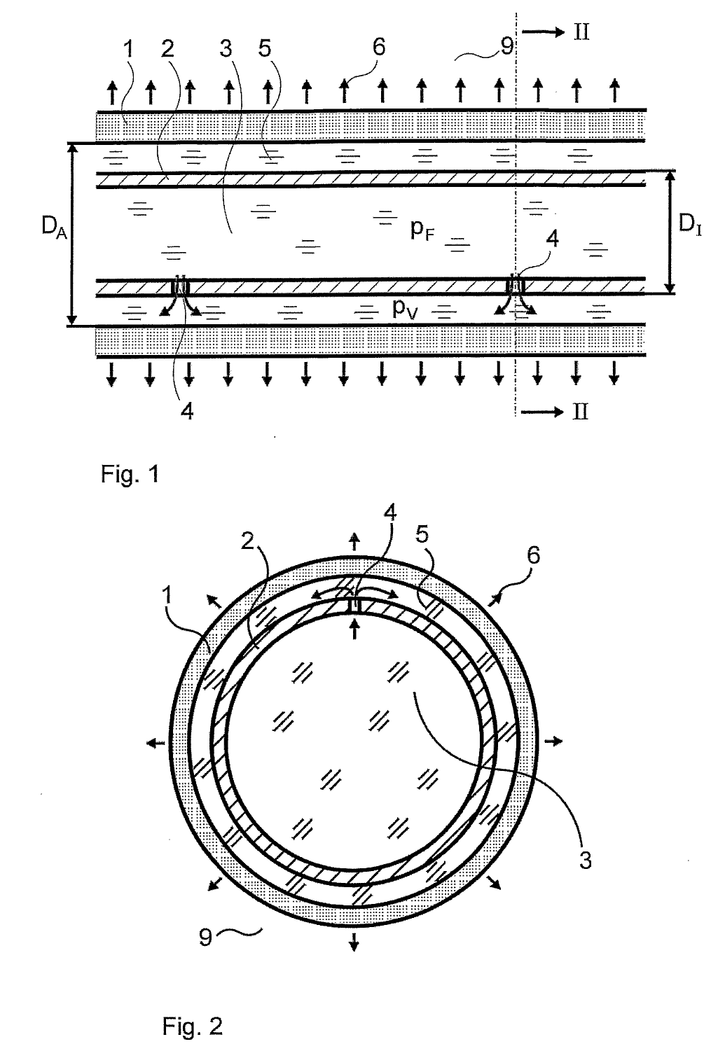

FIG. 1 is a longitudinal section through a tube system that is known per se;

FIG. 2 is a section through the tube system in accordance with FIG. 1 along the line II-II, rotated 180°;

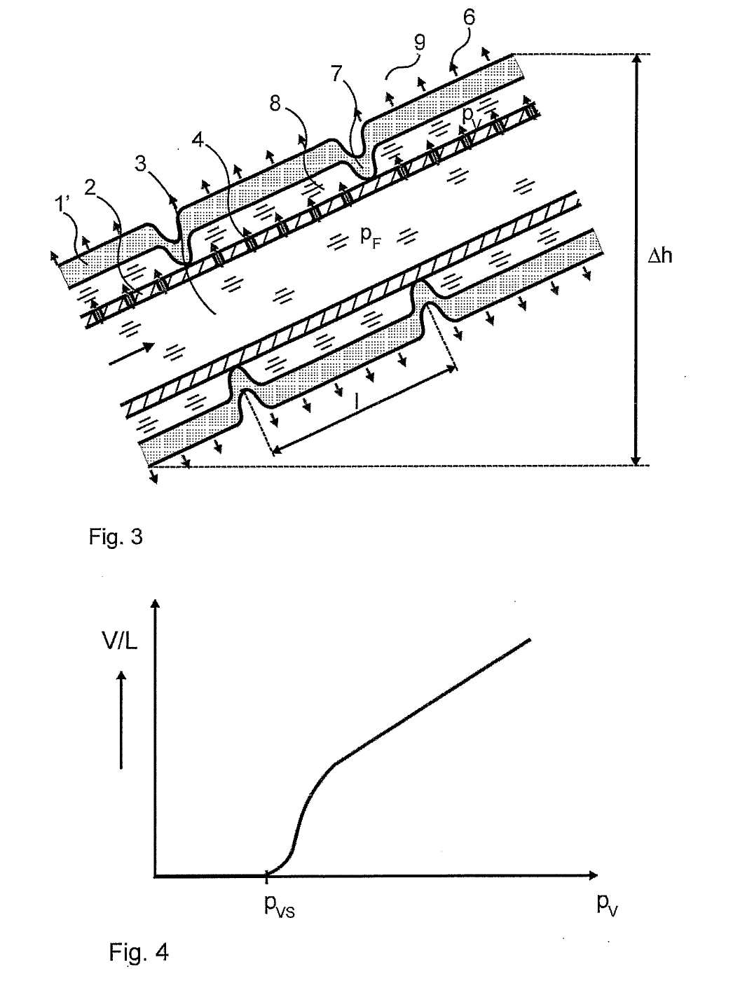

FIG. 3 is a longitudinal section through the tube system, on an incline, in accordance with one exemplary embodiment of the invention;

FIG. 4 is a graphic for visualizing the fluid quantity V flowing out per unit L of length of the tube system as a function of the fluid pressure p_{V} in a tube system with a porous tube with pressure threshold p_{VS}.

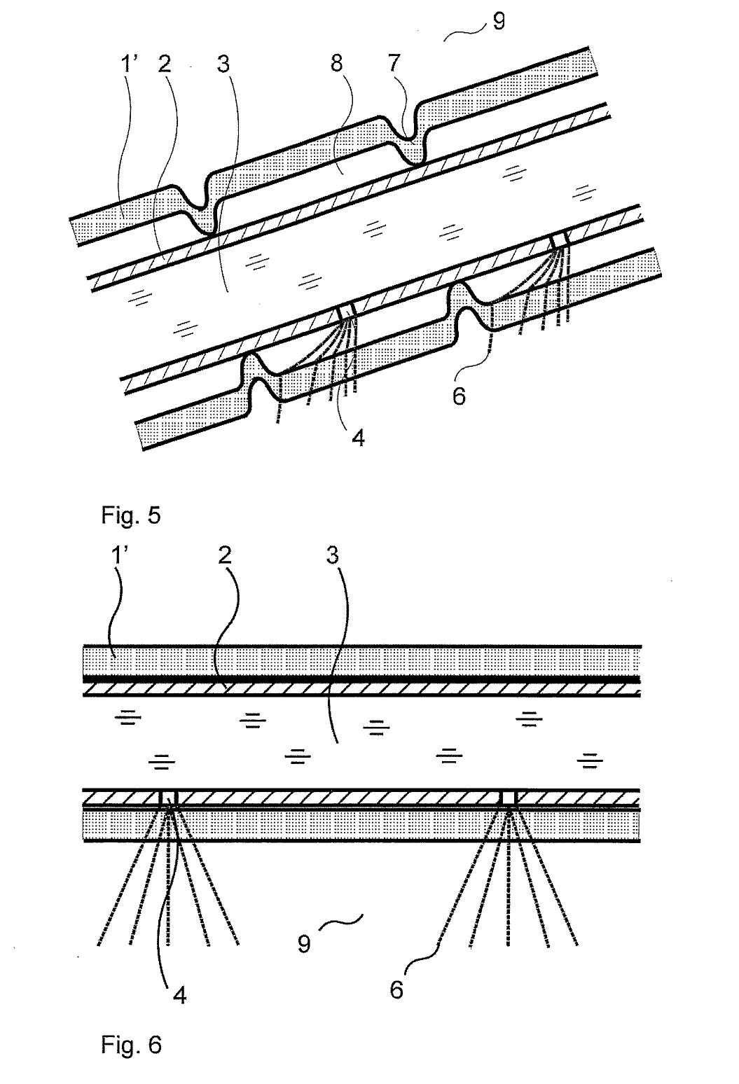

FIG. 5 is a longitudinal section through the tube system according to a modified exemplary embodiment of the invention, having an outer tube, without a pressure threshold, with constrictions and on an incline;

FIG. 6 is a longitudinal section through the inventive tube system, having an expanded inner tube;

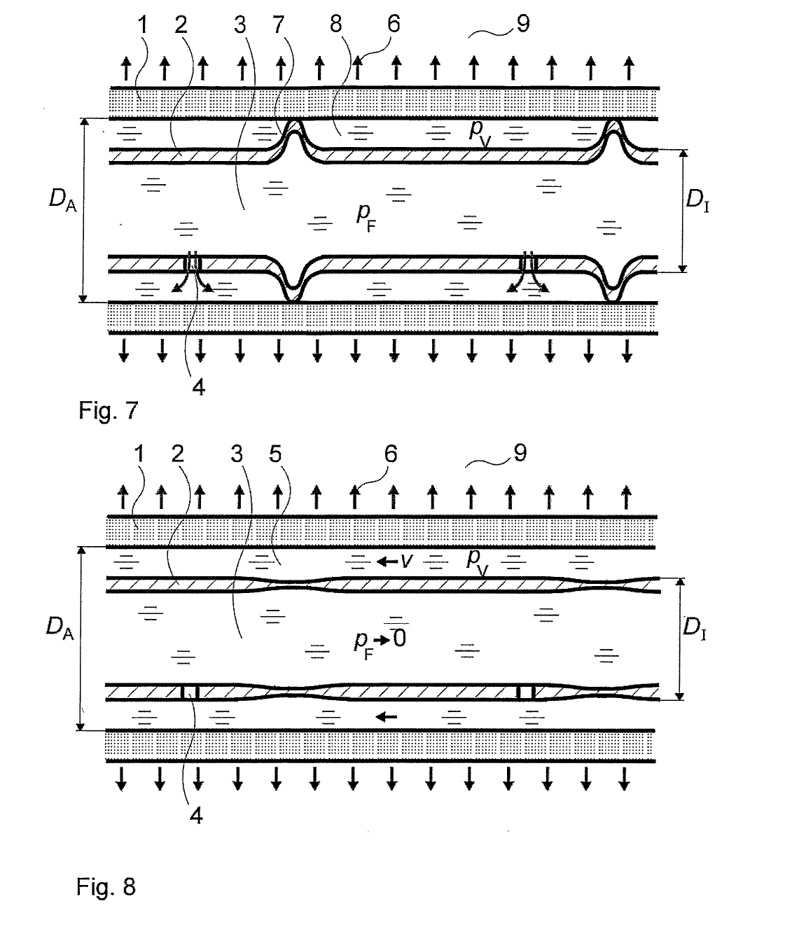

FIG. 7 is a longitudinal section through the tube system, similar to FIGS. 3 and 5, while operating;

FIG. 8 is a longitudinal section through the tube system in accordance with FIG. 7, but with reduced pressure in the inner tube;

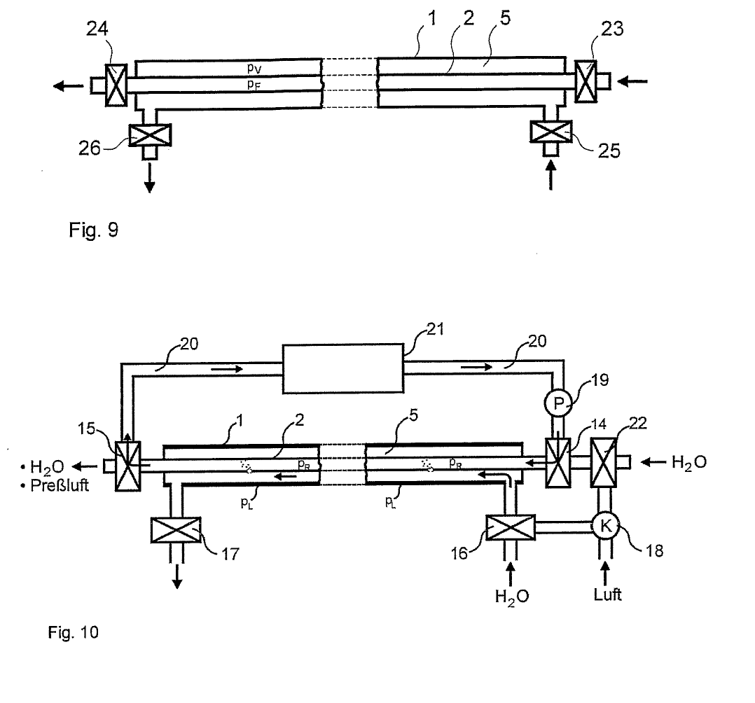

FIG. 9 is a schematic depiction of the tube system, the inner tube and buffer chamber of which can be connected to fluid sources via controllable valves;

FIG. 10 is a schematic depiction similar to the depiction in accordance with FIG. 9 of a tube system with compressed air connectors;

FIG. 11 is a partial view of an inner tube having a modified portioning hole;

FIG. 12 is a longitudinal section through the tube segment in accordance with FIG. 11;

FIG. 13 is a partial view of a tube segment having a portioning hole in accordance with a second exemplary embodiment;

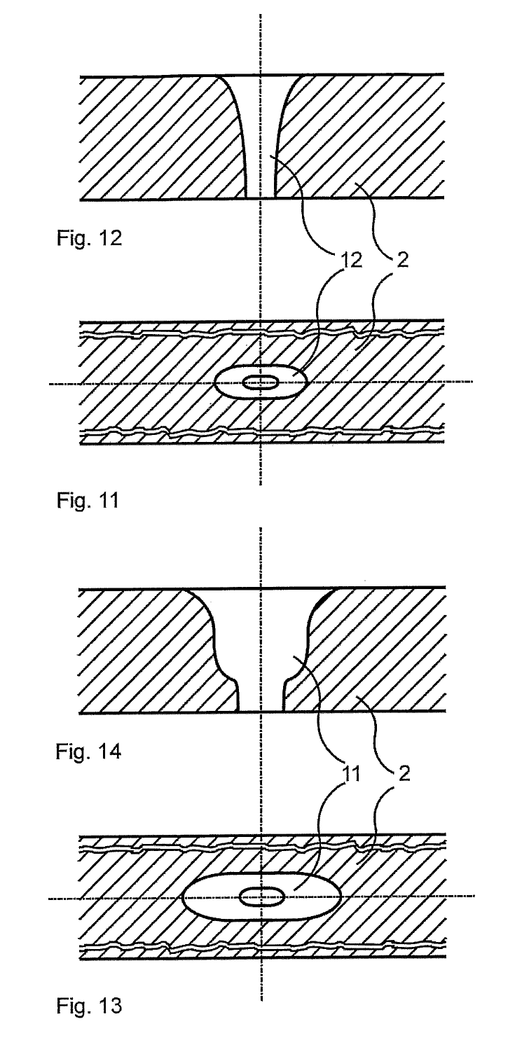

FIG. 14 is a longitudinal section through the tube segment in accordance with FIG. 13;

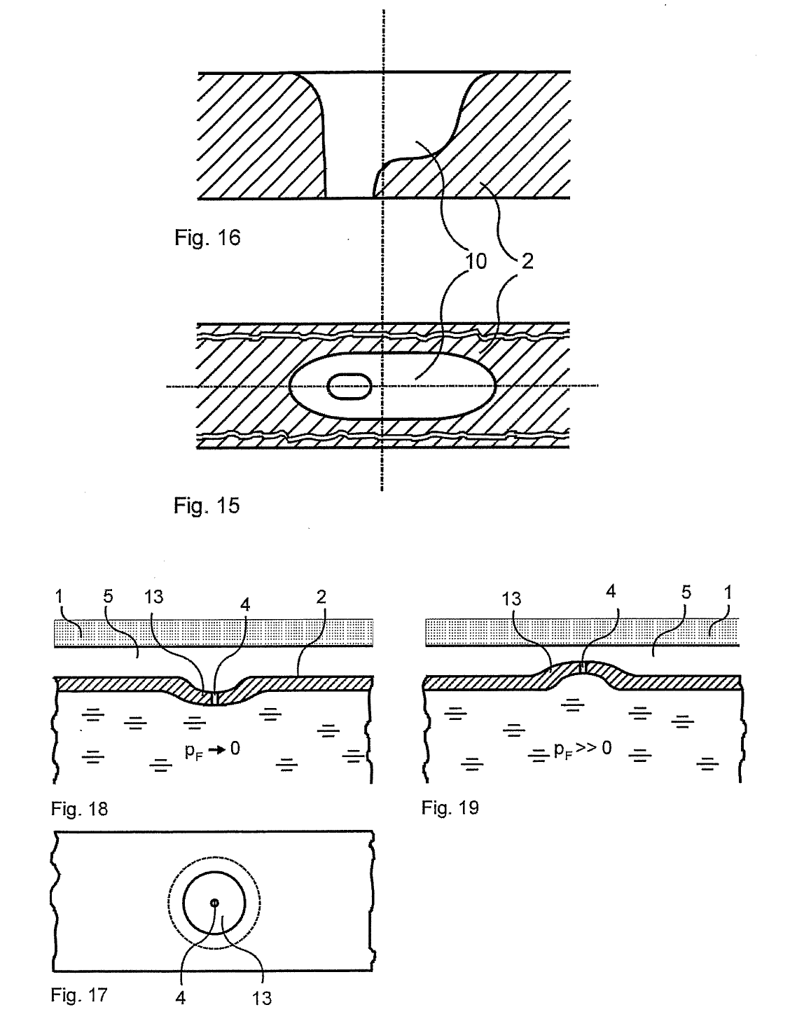

FIG. 15 is a partial view of a tube segment having a portioning hole in accordance with a third exemplary embodiment

FIG. 16 is a longitudinal section through the tube segment in accordance with FIG. 15;

FIG. 17 is a partial view of a tube segment having a portioning hole in accordance with a fourth exemplary embodiment;

FIG. 18 is a partial longitudinal section through a tube system having an inner tube in accordance with FIG. 17, with reduced internal pressure; and,

FIG. 19 is a longitudinal section in accordance with FIG. 18, with elevated internal pressure.

FIGS. 1 and 2 depict the longitudinal section and cross-section of basic structure of the tube system, as is known per se from e.g. FR 2 713 044 A.

This tube system comprises a porous mechanically and chemically stable material.

Arranged inside the outer tube 2 is an inner tube 2, the exterior diameter D₁ of which is smaller than the interior diameter DA of the outer tube 1. Thus an annular space forms between the outer tube 1 and the inner tube 2; hereinafter it is called the buffer volume or buffer chamber 5.

The inner tube 2, which preferably comprises a fluid-tight material, has apertures distributed across its length, hereinafter called portioning holes 4.

Flowing through the inner tube 2 that is connected to a fluid source is a fluid 3, preferably water, under a pressure p_{F} that ranges from 1 to 8 bar, depending on the length of the tube system.

The fluid 3 travels via the portioning holes 4 into the annular buffer chamber that forms a buffer volume 5 and that fills with fluid until the fluid pressure p_{V} prevailing therein is greater than the pressure threshold p_{S} determined by the material of the outer tube 1. Then the fluid flows out into the tube surroundings 9.

The choking effect of the outer tube 1 can be attained with a tube comprising porous material, e.g. a soaker tube, floating tube, or membrane tube.

Since the quantity of the fluid 6 flowing through the outer tube 1 in general is greater than the quantity supplied through the portioning holes 4 into the buffer volume 5, after a certain period of time the pressure in the buffer volume p_{V} collapses, so that the outflow of fluid 6 is interrupted until a pressure p_{V} that is greater than the threshold pressure p_{S} has built up again in the buffer volume.

Thus, using this buffer volume the outflowing fluid 6 is automatically regulated corresponding to the rate of the fluid flowing out through the portioning holes 4.

When the material selected for the outer tube 1 is suitable, the distance between portioning holes 4 and the pressure p_{F} of the fluid in the inner tube 2 can be matched to one another such that the quantity of the outflowing fluid 6 is largely constant across long lengths of the tube system.

Materials that are suitable for inner and outer tubes 1 and 2 are polymer materials, whereby the inner tube 2 should comprise a flexible, fluid-tight polymer material, while the outer tube can comprise a more stable, but still flexible, porous polymer material. Mixtures of rubber and polymers have proved themselves for materials. This material selection attains sufficient flexibility with good robustness and high resistivity to external factors.

Differences in elevation in the terrain in which the hose system is to be placed have a negative impact on the outflow quantity due to the gravitational pressure p_{G} that acts on the fluid and that is a factor of the elevation difference Δₕ, so that a uniform fluid outflow cannot be attained with the system in accordance with FIGS. 1 and 2 with nothing further.

For such cases, the inventive design of the tube system depicted in FIGS. 3 and 6 is suitable; in it, the buffer volume is divided by constrictions 7 of the outer tube 1′ into individual fluid provision chambers 8. Into these chambers 8 open portioning holes 4, the cross-sections of which are significantly larger than the cross-sections of the pores of the outer tube 1′ placed in the area of the chambers 8. Even in an inclined arrangement of the tube system, this configuration causes the chambers 8 to be filled with fluid that flows out into the tube surroundings 9 when the pressure threshold p_{S} is exceeded. Thus, despite the elevation-dependent gravitational pressure p_{G}, the fluid is uniformly supplied to the tube surroundings 9.

A largely constant fluid supply is made possible, even when there are major inclines in the terrain, by appropriately adapting the length 1 of the provision chambers 8 and the number of portioning holes 4 that open into each chamber 8.

This property is promoted in that that porous material of the outer tube 1′ is selected such that it possesses a pressure threshold p_{S} that must be overcome for the fluid to flow out.

In this case the outflow characteristics that result are those illustrated graphically in FIG. 4.

If the pressure p_{V} in the provision chamber 8 is less than the pressure threshold p_{VS}, no fluid flows out.
V/L=0

If the pressure p_{V} exceeds the threshold value p_{VS}, the fluid volume V/L related to the length unit initially quickly increases in a non-linear manner, and then at higher pressures ultimately runs approximately proportional to the pressure p.

Despite these advantageous properties, however, porous outer tubes can also be used whose material does not cause a pressure threshold p_{S}.

In this case the fluid flows out into the surroundings the portioning holes of the inner tube directly through the wall of the outer tube so that the fluid does not flow out uniformly in the tube surroundings. However, this can be tolerated e.g. for subsoil irrigation because the soil ensures uniform distribution of the fluid due to diffusion.

Even when the tube system is placed on an incline, outer tubes without a pressure threshold can be used if the tube system is segmented as FIG. 5 depicts and as is explained using FIG. 3. The provision chambers 8, into each of which at least one portioning hole 4 of the inner tube 2 opens, ensure that there is a sufficient uniform supply of the fluid to the tube surroundings 9.

If the entire length of the inner tube 2 comprises highly elastic material, as FIG. 6 depicts, increasing the pressure can cause it to be positioned against the inner wall of the outer tube 1′, forcing the constrictions 7 back. The segmented buffer chamber explained in the foregoing is then eliminated so that the fluid passes through the portioning holes 4 directly through the outer tube 1′ into the adjacent area of the tube surroundings 9, as indicated by the broken line.

If, as is also possible, the material of the outer tube 1′ possesses a pressure threshold, a small buffer volume (not shown) forms in the vicinity of each portioning hole 4, from which the fluid flows outward when its pressure exceeds the threshold pressure.

FIGS. 7 and 8 illustrate a tube system in which self-segmentation is possible. The buffer volume disposed between the outer tube 1 and the inner tube 2 is divided, specifically segmented, by convexities 7′ that are positioned against the inner wall of the outer tube 1 by the working pressure p_{F} of the fluid 3 in the interior of the inner tube 2. The wall thickness of the inner tube 2 in the area of the bulge 7′ is thinner than the wall thickness of the adjacent areas of the inner tube 2 so that given normal working pressure p_{F} and suitable elasticity of the inner tube 2 there is bulging, that is, the bulges 7′ under pressure are positioned against the inner wall of the outer tube 1.

If this working pressure p_{F} in the inner tube is reduced to a value that is less than or equal to the inner pressure p_{V} in the buffer chamber, that is, in the provision chambers 8, the bulges 7′ move back so that the segmentation is eliminated, as depicted in FIG. 8. In this case the fluid can flow not only in the inner tube 2, but also in the area between the inner tube 1 and the outer tube 2.

This design enables a number of working options.

The most water-saving supply of water results when the inner pressure p_{F} in the inner tube 2 is greater than the inner pressure p_{V} in the provision chambers 8 so that the result is the setting in FIG. 7. By dimensioning the inner diameter DA of the outer tube 1 and the outer diameter D₁ of the inner tube 2 in a suitable manner and by reducing the wall thickness of the inner tube 2 in the area of the bulge 7′, when there is a sufficient increase in the working pressure p_{F} in the inner tube 2 the bulges 7′ are positioned against the inner wall of the outer tube 1 with a good sealing effect.

In contrast, if more water supply is desired, the working pressure p_{F} in the inner tube 2 must be reduced until the setting in accordance with FIG. 8 is reached.

This setting moreover enables rinsing and thus cleaning of the tube system, as is explained in detail in the following using FIGS. 9 and 10.

In order to enable this cleaning, inner tube 2 and outer tube 3 are each provided with controllable valves 23 and 24 or 25 and 26 at the input and output, as illustrated in FIG. 9.

If the inner tube 2 is to be cleaned, valves 23 and 24 are opened so that fluid can flow through under pressure.

In like manner, for cleaning the buffer chamber 5, the valves 25 and 26 are opened in order to enable unimpeded flow of the fluid. The cleaning of the buffer chamber 5 naturally requires that the segmentation according to the depiction in FIG. 8 is eliminated.

If it is intended that the pores of the outer tube 1 are to be cleaned, the valve 26 must be closed so that the fluid is pressed through the pores.

If water is used for cleaning, in some cases this can lead to silting of the ground due to the amount of water supplied during the cleaning procedure. To avoid this, a compressed gas, preferably air, can be added to the buffer chamber 5 instead of water, and it enters the tube surroundings, that is the ground, through the pores of the outer tube 1.

In the irrigation mode, all of the valves 24, 25, and 26 should be closed except for the valve 23.

The circuit depicted schematically in FIG. 10 permits even more effective cleaning of the tube system. It is recommended that this system be used when the portioning holes to be cleaned are particularly small. When switched, the buffer chamber 5 can be connected via a three-way valve 16 alternatively to a water connector H₂O or to a compressed air source 18. As in the arrangement in accordance with FIG. 9, the output of the buffer chamber can be closed with a controllable valve 17. The inner tube 2 can be connected via three-way valve 22 alternatively to a water connector (H₂O) or to the compressed air source 18, e.g. a compressor. A three-way valve 15 is also provided at the output of the inner tube 2, and it can be switched such that the fluid disposed in the tube 2, specifically water, is pressed out using compressed air.

In the other switch position, the three-way valve 15 connects the inner tube 2 via lines 20 to a reservoir 21 for a cleaning agent. This cleaning agent is circulated by means of circulation pump 19 and is added to the inner tube 2 via a three-way valve switched between the cleaning valve 22 and the input for the inner tube 2.

The tube system can be cleaned very well e.g. when placed in the ground by means of such an arrangement. A cleaning cycle could proceed e.g. as follows:
1. The three-way valves 14, 15, and 22 are opened for compressed air to pass through. The water still disposed in the inner tube 2 is pressed out via the opened valve by means of the compressed air produced by the compressor 18.
2. The buffer chamber 5 is connected to the compressor 18 via the three-way valve 16. The water disposed in the buffer chamber is pressed out via the opened three-way valve 17 by means of the compressed air.
3. The valve 17 is closed. A defined pressure p_{L} is built up in the buffer chamber 5 by means of the compressor 18.
4. For cleaning the inner tube 2 with a cleaning agent disposed in the reservoir 21, the three-way valves 14 and 15 are switched to the cleaning agent cycle. The pump 19 ensures that the cleaning agent is circulated out of the reservoir 21 via lines 20, thus flowing through the inner tube 22. In order to prevent cleaning agent from travelling into the buffer chamber 5, the pressure of the cleaning agent P_{R} must be less than the pressure p_{L} of the compressed air in the buffer chamber 5.
5. The cleaning agent can act for a prespecified period of time with continuous circulation.
6. After the cleaning has concluded, the compressor 18 is connected to the inner tube 2 via the three-way valves 14 and 22, which have now been switched, so that the cleaning agent is pressed back out of the inner tube into the reservoir 21.
7. The three-way valves 15 and 22 are switched to water through-put so that the inner tube 2 is rinsed with water.
8. The three-way valve 15 is closed so that water added to the inner tube in the manner described in the foregoing can flow out after the segmentation has built up via the outer tube 1.

This circuit, together with the inventive self-segmentation of the tube, makes possible various applications for controlled irrigation, cleaning, adding of fluid and gaseous fluids, and heating.

This arrangement is primarily for basic cleaning of the entire tube system, whereby it is possible to clean the most sensitive sites in the system in a controlled manner, specifically the portioning holes in the inner tube, and to protect them against soiling, without great complexity. Such basic cleaning does not have to be performed except after long intervals of time, e.g. non-irrigation seasons.

Other options for self-cleaning of the portioning holes are illustrated in FIGS. 11 through 19. The designs of the portioning holes that are depicted in these figures are intended to prevent particularly critical effects of clogging or overgrowth. The objective of this design is to cause the crusts that occur e.g. due to calcification or the formation of layer of rust, which crusts are particularly feared and very difficult to eliminate, to flake off using an intentional “kneading” process, it then being very simple to rinse out the particles that have flaked off.

This “kneading” process in the immediate vicinity of the portioning holes can be attained using the designs for the hole cross-sections illustrated in FIGS. 11 through 19.

The portioning hole 12 depicted in FIGS. 11 and 12 has a funnel-shaped cross-section. With sufficient variation in the pressure difference between inner tube and buffer chamber, the hole cross-section deforms such that sold crusts within or in the area of the hole 12 flake off and even soft clogs e.g. from autonomous growth can be eliminated.

Modifications to this funnel-shaped cross-section of the hole are illustrated in FIGS. 14 through 16. These symmetrical and asymmetrical tulip shapes 10 and 11 for the portioning holes promote the flaking during the “kneading” process.

Another variant of the portioning hole that promotes self-cleaning by “kneading” is illustrated in FIGS. 17 through 19. In this variant, provided in the area of the portioning hole 4 is a circular disk-shaped indentation 13 that is disposed inward when the fluid pressure p_{F} in the interior of the inner tube 2 is low. Preferably the wall thickness of the inner tube 2 is thinner in the area of the indentation 13.

As soon as the working pressure p_{F} in the inner tube 2 is increased, the indentation 13 bulges out of the position illustrated in FIG. 18 into the position in accordance with FIG. 19. This transition leads to the desired “kneading” effect in the area of the portioning hole 4, resulting in the cleaning described above. Care should be taken that inner tube and outer tube are dimensioned such that when the working pressure is attained in the inner tube the indentation 13 does not come into contact with the inner wall of the outer tube 1.

Legend

1,1′ Outer tube
2 Inner tube
3 Fluid
4 Portioning hole
5 Buffer chamber, buffer volume
6 Outflowing fluid
7 Constriction
7′ Convexity
8 Provision chamber
9 Tube surroundings
10 Funnel-shaped or tulip-shaped portioning holes
11 Funnel-shaped or tulip-shaped portioning holes
12 Funnel-shaped or tulip-shaped portioning holes
13 Circular indentation
14 Three-way valve
15 Three-way valve
16 Three-way valve
17 Valve
18 Compressed air source, compressor
19 Circulation pump
20 Lines for cleaning agent
21 Reservoir for cleaning agent
22 Three-way valve
23 Valve
24 Valve
25 Valve
26 Valve
D_{A} Inner diameter of outer tube
D₁ Outer diameter of inner tube
p_{G} Gravitational pressure of fluid
p_{VS} Pressure threshold for fluid outflow from outer tube
p_{F} Pressure of fluid in inner tube
p_{V} Pressure of fluid in buffer volume
p_{R} Pressure of cleaning agent in inner tube
p_{L} Pressure of compressed air in buffer chamber
I Length of provision chamber
Δh Difference in elevation

1. Tube system for supplying a fluid, preferably water for subsoil irrigation, comprising an outer tube made of porous material and an inner tube arranged therein, spaced apart there from, forming a buffer chamber, and made of a material that is non-permeable for fluid, which inner tube has portioning holes that open into said buffer chamber for said fluid to flow through,
characterized in that said buffer chamber (5) is divided into individual provision chambers (8), into each of which a portioning hole (4) of said inner tube (2) opens, and in that the cross-section of the pores of said outer tube are significantly smaller than the cross-section of said portioning holes.

2. Tube system in accordance with claim 1,
characterized in that for forming said provision chambers (8) said outer tube (1) has constrictions (7) that are preferably positioned equidistant against the outer side of said inner tube (2).

3. Tube system in accordance with claim 1,
characterized in that for forming provision chambers (8′) said inner tube preferably has equidistant annular convexities (7′) that are positioned against the inner surface of said outer tube (1′).

4. Tube system in accordance with claim 3,
characterized in that for forming annular convexities (7′) the wall thickness of the inner tube (2′), which comprises elastic material,
is thinner compared to the adjacent inner tube walls when the fluid pressure is increased in the interior of said inner tube (2′).

5. Tube system in accordance with claim 4,
characterized in that for self-segmentation of said buffer chamber said annular convexities are dimensioned and said inner tube has an elasticity such that when the pressure in said inner tube is increased relative to the pressure in said buffer chamber said annular convexities are positioned sealingly against the inner surface of said outer tube and such that when the pressure in said inner tube is reduced the diameter of said annular convexities is reduced and said provision chambers re-connect with one another.

6. Tube system in accordance with claim 5,
characterized in that said inner tube and said buffer chamber can be connected via controllable valves, each with a discrete fluid source, preferably with a water connector and/or a compressed air source.

7. Tube system in accordance with claim 6,
characterized in that said fluid, preferably water for the purpose of rapid irrigation, can be fed into said buffer chamber when the pressure in said inner tube is reduced.

8. Tube system in accordance with claim 6,
characterized in that, for the purpose of cleaning, a fluid, preferably water or compressed air, can be fed under high pressure into said inner tube and/or into said buffer chamber when the pressure in said inner tube is reduced.

9. Tube system in accordance with claim 8,
characterized in that the pressure in said inner tube and/or said buffer chamber is varied for cleaning purposes.

10. Tube system in accordance with claim 9, characterized in that brief pressure shocks at time intervals are generated in intervals in said inner tube and/or said buffer chamber.

11. Tube system in accordance with claim 1,
characterized in that said inner tube (2) across its entire length possesses elasticity that is great enough that when the fluid pressure is increased in its interior it is positioned against the inner wall of said outer tube (1′) such that said fluid flows out directly through said outer tube (1′) in the vicinity of said portioning holes (4) of said inner tube (2).

12. Tube system in accordance with claim 2,
characterized in that said constrictions (7) of said outer tube (1′) or said convexities (7′) of said inner tube (2′) are joined fluid-tight, preferably welded, to said inner tube (2) or said outer tube (1′).

13. Tube system in accordance with claim 12,
characterized in that outer tubes and inner tubes comprise thermoplastic material and said material of said outer tube or of said inner tube possesses a lower melting point than said material of said inner tube or said outer tube.

14. Tube system in accordance with claim 1, characterized in that outer and inner tubes (1′, 2) comprise a polymer material, whereby the material of said inner tube (2) possesses greater elasticity.

15. Tube system in accordance with claim 14,
characterized in that said outer tube (1′) is a soaker tube, floating tube, or membrane tube that comprises porous material.

16. Tube system in accordance with claim 15,
characterized in that said outer tube comprises a mixture of rubber and polymer material.

17. Tube system in accordance with claim 1, characterized in that the ratio of the pore diameter of said outer tube (1, 1′) to the diameter of said portioning holes (4) of said inner tube (2) is on the order of magnitude of 1:10 to 1:100 and the diameter of said portioning holes (4) of said inner tube (2) is on the order of magnitude of 100 μm, the fluid pressure within said inner tube (2) being 1 to 10 bar.

18. Tube system in accordance with claim 1, characterized in that said material of said outer tube (1′) is selected and its apertures are dimensioned such that the latter do not open unless a pre-specified pressure threshold is exceeded, preferably at 0.3 bar.

19. Tube system in accordance with claim 1, characterized in that said portioning holes (10, 11, 12) of said inner tube (2) deviate from the cylindrical shape and are preferably funnel-shaped.

20. Tube system in accordance with claim 1, characterized in that the wall of said inner tube (2) is somewhat circularly indented in the area of said portioning holes (4) and has a thinner wall thickness in said area.

21. Tube system in accordance with claim 1, characterized in that the position of said provision chambers (8) and the number of said portioning holes (4) of said inner tube (2) that open therein are matched to one another such that the loss in pressure in said inner tube (2) that is a factor of the tube length and the reduction in the quantity of said fluid flowing out through said portioning holes (4) of said inner tube (2) that is caused thereby is compensated for attaining a constant fluid outflow quantity per unit of length of said tube system.

22. Tube system in accordance with claim 1, characterized in that liquid fertilizers can be supplied via said inner tube and/or said buffer chamber.

23. Tube system in accordance with claim 1, characterized in that a warm fluid can be added to said inner tube and/or said buffer chamber.

24. Tube system in accordance with claim 1, characterized by an input filter upstream of said system that filters out impurities such as suspended organic and inorganic particles.
